(19) United States
(12) Patent Application Publication
(10) Pub. No.: US 2022/0315456 A1
(43) Pub. Date: Oct. 6, 2022

(54) SYSTEM AND METHOD FOR HARVESTING MINERALS FROM DESALINATION BRINE

(71) Applicant: Ahmed Saleh Alamoudi, Al-Jubail (SA)

(72) Inventor: Ahmed Saleh Alamoudi, Al-Jubail (SA)

(21) Appl. No.: 17/220,382

(22) Filed: Apr. 1, 2021

(51) Int. Cl. C02F 1/469; C02F 1/44; C02F 1/52

(52) U.S. Cl. CPC C02F 1/4693; C02F 1/442; C02F 1/441; C02F 1/52; C02F 2103/08

(57) ABSTRACT

The system for harvesting minerals from desalination brine includes a desalination module for receiving a stream of saltwater and producing a stream of purified water and a stream of desalination brine. A separator receives a first portion of the stream of desalination brine and separates monovalent ions from multivalent ions in the stream of desalination brine. The separator outputs a reject stream including the multivalent ions and a permeate stream including the monovalent ions. A membrane brine concentrator receives the permeate stream and produces a stream of lower concentration saltwater and a stream of higher concentration salt brine. The stream of lower concentration saltwater is mixed with the stream of saltwater received by the desalination module. A crystallizer receives the stream of higher concentration salt brine and produces a crystallized mineral product and a stream of bitterns.

### BACKGROUND

### 1. Field

The disclosure of the present patent application relates to desalination of saltwater, and particularly to a system and method for recovering minerals from the waste products produced by the desalination of saltwater.

### 2. Description of the Related Art

Desalination plants are widely used to produce fresh water from saline water, such as seawater, for example. In general, desalination processes separate the saline water feed into a fresh water stream and a stream of concentrated brine. The concentrated brine is typically considered to be a waste product, and is commonly recycled or disposed of with little additional treatment. However, since the saline water feed often contains a large number of different dissolved ions, the concentrated brine actually contains a large quantity of desirable minerals which may be recovered for a wide variety of purposes. Thus, a system and method for harvesting minerals from desalination brine solving the aforementioned problems is desired.

### SUMMARY

The system for harvesting minerals from desalination brine includes a desalination module for receiving a stream of saltwater, such as seawater or the like, and producing a stream of purified water and a stream of desalination brine. It should be understood that the desalination module may be any suitable type of desalination system. Non-limiting examples of such desalination systems include reverse osmosis desalination systems, multi-stage flash desalination systems, multi-effect distillation desalination systems, and membrane distillation desalination systems. A separator is in fluid communication with the desalination module for receiving a first portion of the stream of desalination brine and separating monovalent ions contained therein from multivalent ions. The separator outputs a reject stream containing the multivalent ions and a permeate stream containing the monovalent ions. A second portion of the stream of desalination brine is expelled as a stream of discharge brine, and the reject stream is mixed with the second portion of the stream of desalination brine. The separator may be any suitable type of separator for separating monovalent ions from multivalent ions. As a non-limiting example, the separator may be a nano-filtration separator. As another non-limiting example, the separator may be an electrodialysis separator.

A membrane brine concentrator is in fluid communication with the separator for receiving the permeate stream and producing a stream of lower concentration saltwater and a stream of higher concentration salt brine. The stream of lower concentration saltwater is mixed with the stream of saltwater received by the desalination module. A crystallizer is in fluid communication with the membrane brine concentrator for receiving the stream of higher concentration salt brine and producing a crystallized mineral product and a stream of bitterns. As used herein, the term “bitterns” has its conventional meaning; i.e., a bitter solution remaining in salt making after the salt has crystallized out of seawater or brine. It should be understood that any suitable type of crystallizer may be used. As a non-limiting example, the crystallizer may be a thermal crystallizer. As another non-limiting example, the crystallizer may be a solar evaporation pond.

In an alternative embodiment, the crystallizer is replaced by a post-purifier, which is also in fluid communication with the membrane brine concentrator for receiving the stream of higher concentration salt brine and producing a highly purified and concentrated salt brine. As a non-limiting example, the post-purifier may be a clarifier. As another non-limiting example, the post-purifier may be a bromide removal module.

These and other features of the present subject matter will become readily apparent upon further review of the following specification.

### BRIEF DESCRIPTION OF THE DRAWINGS

FIG. 1 is a block diagram illustrating a system for harvesting minerals from desalination brine.

FIG. 2 is a block diagram of an alternative embodiment of the system for harvesting minerals from desalination brine.

FIG. 3 is a block diagram of another alternative embodiment of the system for harvesting minerals from desalination brine.

FIG. 4 is a block diagram of still another alternative embodiment of the system for harvesting minerals from desalination brine.

Similar reference characters denote corresponding features consistently throughout the attached drawings.

### DETAILED DESCRIPTION OF THE PREFERRED EMBODIMENTS

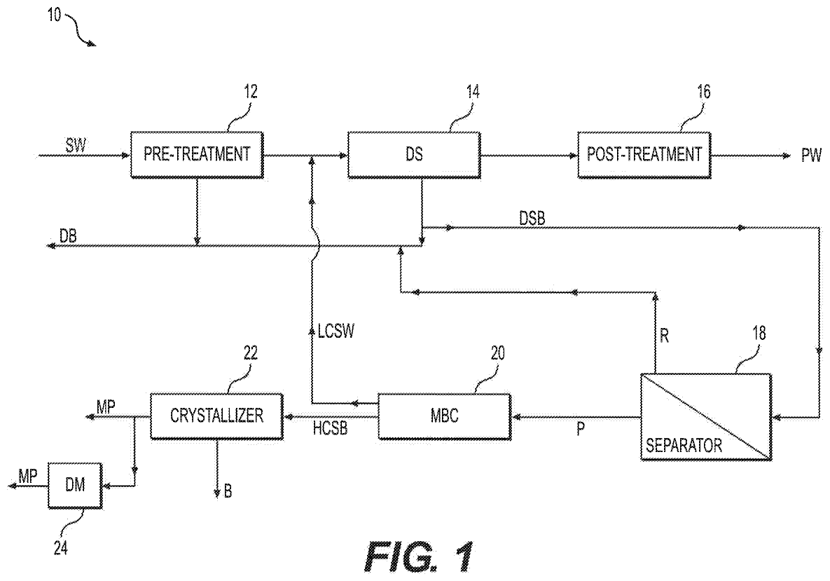

As shown in FIG. 1, the system for harvesting minerals from desalination brine 10 includes a desalination (DS) module 14 for receiving a stream of saltwater (SW), such as seawater or the like, and producing a stream of purified water (PW) and a stream of desalination brine (DSB). It should be understood that the desalination module 14 may be any suitable type of desalination system. Non-limiting examples of such desalination systems include reverse osmosis desalination systems, multi-stage flash desalination systems, multi-effect distillation desalination systems, and membrane distillation desalination systems. As is conventionally known, prior to desalination module 14 receiving the saltwater, the saltwater may first pass through a pre-treatment module 12 for filtering the saltwater, removing chemical waste therefrom, etc. A similar post-treatment module 16 may also be used to enhance the quality of the low salinity water output from the desalination module 14, such as by adding minerals to improve the taste of the purified water product and/or to prevent corrosion of pipes and/or disinfect the purified water.

A separator 18 is in fluid communication with the desalination module 14 for receiving a first portion of the stream of desalination brine and separating monovalent ions contained therein from multivalent ions. The separator 18 outputs a reject (R) stream containing the multivalent ions and a permeate (P) stream containing the monovalent ions. A second portion of the stream of desalination brine is expelled as a stream of discharge brine (DB), and the reject stream is mixed with the second portion of the stream of desalination brine. The permeate stream has an enhanced purity of monovalent ions, and the reject stream has a higher concentration of divalent or multivalent ions. The separator 18 may be any suitable type of separator for separating monovalent ions from multivalent ions. As a non-limiting example, the separator 18 may be a nano-filtration separator. As another non-limiting example, the separator 18 may be an electrodialysis separator. Nano-filtration (NF) is a membrane-based separation method which results in different ionic rejections, dependent upon the size and charge of the ions and their salt diffusion coefficients in water. In general, NF has higher rejection of multivalent ions and lower rejection on monovalent ions. In use for ionic separation, NF permeate will have a higher purity of monovalent ions, while the NF reject (i.e., the “retentate”) will have a higher concentration of multivalent ions. A similar manner of ion separation is found using electrodialysis (ED).

A membrane brine concentrator (MBC) 20 is in fluid communication with the separator 18 for receiving the permeate stream and producing a stream of lower concentration saltwater (LCSW) and a stream of higher concentration salt brine (HCSB). The stream of lower concentration saltwater is mixed with the stream of saltwater received by the desalination module 14. It should be understood that any suitable type of membrane brine concentrator may be used. Non-limiting examples of membrane brine concentrators include osmotically assisted reverse osmosis (OARO) concentrators, which may use various types of membranes, including, but not limited to, hollow fine fiber-forward osmosis (HFF-FO) membranes, spiral wound-forward osmosis (SW-FO) membranes, reverse osmosis (RO) membranes, and NF membranes

A crystallizer 22 can be in fluid communication with the membrane brine concentrator 20 for receiving the stream of higher concentration salt brine and producing a crystallized mineral product (MP) and a stream of bitterns (B). As used herein, the term “bitterns” has its conventional meaning; i.e., a bitter solution remaining in salt after the salt has crystallized out of seawater or brine. It should be understood that any suitable type of crystallizer may be used. As a non-limiting example, the crystallizer 22 may be a thermal crystallizer. As another non-limiting example, the crystallizer 22 may be a solar evaporation pond.

During crystallization in crystallizer 22, the purity of the monovalent ions (e.g., NaCl) is enhanced because the ionic proportions in the brine are changed during concentration and crystallization. As a non-limiting example, where seawater is used as the source of the saltwater, aragonite (CaCO₃) and gypsum/anhydrate (CaSO₄.2H₂O/CaSO₄) may precipitate first, followed by halite (NaCl) precipitates, and then epsomite (MgSO₄.7H₂O), kainite (KMgClSO₄.3H₂O), sylvite (KCl), carnallite (KMgCl₃.6H₂O), borates and celestite (SrSO₄) precipitates.

Since a large portion of magnesium (Mg⁺⁺) is removed by separator 18, it becomes easier to harvest potassium (K⁻), bromide (Br⁻) and other minerals from the bitterns output by crystallizer 22. For the non-limiting example of seawater used as the source of saltwater, the final mineral product (MP) has an enhanced purity of 99.0% or more, with additional enhancements resulting in a purity between approximately 99.5% and 99.9%, dependent upon the method of washing used during crystallization. For example, a purity of 99.9% NaCl can be achieved using vacuum salt washing.

Additionally, as shown in FIG. 1, a dissolving mixer (DM) 24 may be used to produce high purity, highly concentrated NaCl brine from at least a portion of the produced crystal salt output from crystallizer 24. In the dissolving mixer 24, the distillate produced during crystallization may be used as a solvent to dissolve the crystal salt if available, since the distillate is typically very high purity water. Alternatively, the purified water produced by desalination module 14 may also be used as a solvent. Using either solvent, very high purity NaCl brine (with a purity level similar to crystal salt) can be produced at any desired concentration.

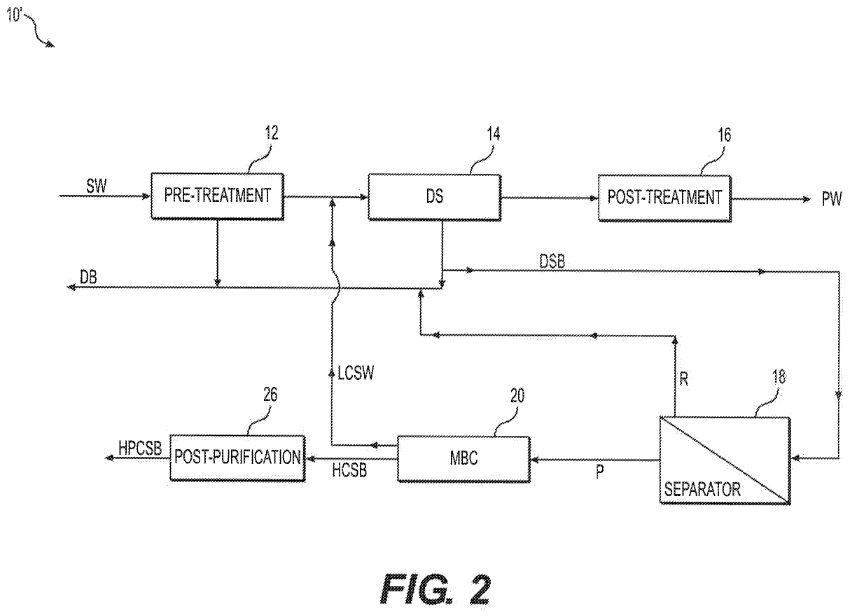

In the alternative embodiment of FIG. 2, the system and method for harvesting minerals from desalination brine 10′ is similar to the system and method for harvesting minerals from desalination brine 10 of FIG. 1, but the crystallizer 22 has been replaced by a post-purifier 26. The post-purifier 26 is also in fluid communication with the membrane brine concentrator 20 for receiving the stream of higher concentration salt brine and producing a highly purified and concentrated salt brine (HPCSB). As a non-limiting example, the post-purifier 26 may be a clarifier. In this example, the clarifier may have an NaOH dosage to remove or reduce Magnesium (Mg⁺⁺) content in the concentrated brine. As another non-limiting example, the post-purifier 26 may be a bromide removal module for removing or reducing the bromide (Br⁻) content in the concentrated brine. As a further non-limiting example, the post-purifier 26 may include both a clarifier and a bromide removal module. In use, the clarifier could also produce a Mg(OH)₂ byproduct, and the bromide removal module could produce a bromine (Br₂) byproduct.

Tables 1 and 2 below show exemplary ion compositions to illustrate the production of the highly purified and concentrated salt brine from seawater reverse osmosis (SWRO) brine reject. In this example, the total dissolved solids (TDS) of SWRO brine is 74,540 ppm, where NaCl is 84.9% of the TDS. Nano-filtration (NF) is used as the separation process in separator 18. In this example, the NF permeate has a lower TDS of 59,990 ppm compared to the NF feed (i.e., the SWRO brine), and the portion of NaCl is 96.5% in the NF permeate. The membrane brine concentrator 20 does not change the composition of dissolved minerals significantly, but concentrates the brine, resulting in a TDS of 250,000 ppm in the highly concentrated salt brine output from membrane brine concentrator 20.

For system 10 of FIG. 1, where crystallization is used, the product can be either crystal salt or the concentrated brine, following dissolving mixer 24. In Tables 1 and 2, the exemplary ion composition of 250,000 ppm brine from the dissolving mixer 24 is provided, where the NaCl portion is 99.5%. It is assumed that the composition of this brine has the same composition as the crystal NaCl salt from crystallizer 22.

With regard to system 10′ of FIG. 2, the clarifier 26 mostly removes magnesium and sulfate, as well as some calcium and potassium. It should be noted that that magnesium and sulfate concentration could drop to zero with sufficient NaOH dosage. Bromide removal further purifies the brine, and the final NaCl portion is expected to be about 99.1% of the total TDS. In Table 2, “*” indicates that the data follows the use of dissolving mixer 24 in system 10 of FIG. 1, and “**” indicates that the data follows the use of post-purifier 26 in system 10′ of FIG. 2, where post-purifier 26 includes both a clarifier and a bromide removal module.

TABLE 1
Exemplary Ion Balances

| | | SWRO | NF | Brine after |
|---|---|---|---|---|
| | Ions | Brine | Permeate | Membrane BC |
| Chloride | Cl⁻ | 40,600 | 36,200 | 150,800 |
| Sodium | Na⁺ | 22,700 | 21,700 | 90,500 |
| Sulfate | SO₄⁻ | 6,400 | 140 | 600 |
| Magnesium | Mg⁺⁺ | 2,700 | 580 | 2,400 |
| Calcium | Ca⁺⁺ | 800 | 310 | 1,300 |
| Potassium | K⁺ | 900 | 790 | 3,300 |
| Bicarbonate | HCO₃⁻ | 300 | 150 | 600 |
| Bromide | Br⁻ | 140 | 120 | 500 |
| | TDS | 74,540 | 59,990 | 250,000 |
| | NaCl/TDS | 84.9% | 96.5% | 96.5% |

TABLE 2
Exemplary ion Balances

| | | Brine from | | |
|---|---|---|---|---|
| | | Crystallizer | Brine after | Brine after |
| | Ions | Salt * | Clarifier ** | Br Removal ** |
| Chloride | Cl⁻ | 151,870 | 150,800 | 150,800 |
| Sodium | Na⁺ | 97,000 | 95,000 | 95,000 |
| Sulfate | SO₄⁻ | 10 | 53 | 53 |
| Magnesium | Mg⁺⁺ | 20 | 24 | 24 |
| Calcium | Ca⁺⁺ | 150 | 572 | 572 |
| Potassium | K⁺ | 800 | 1,485 | 1,485 |
| Bicarbonate | HCO₃⁻ | 30 | 210 | 210 |
| Bromide | Br⁻ | 120 | 500 | 5 |
| | TDS | 250,000 | 248,644 | 248,149 |
| | NaCl/TDS | 99.5% | 98.9% | 99.1% |

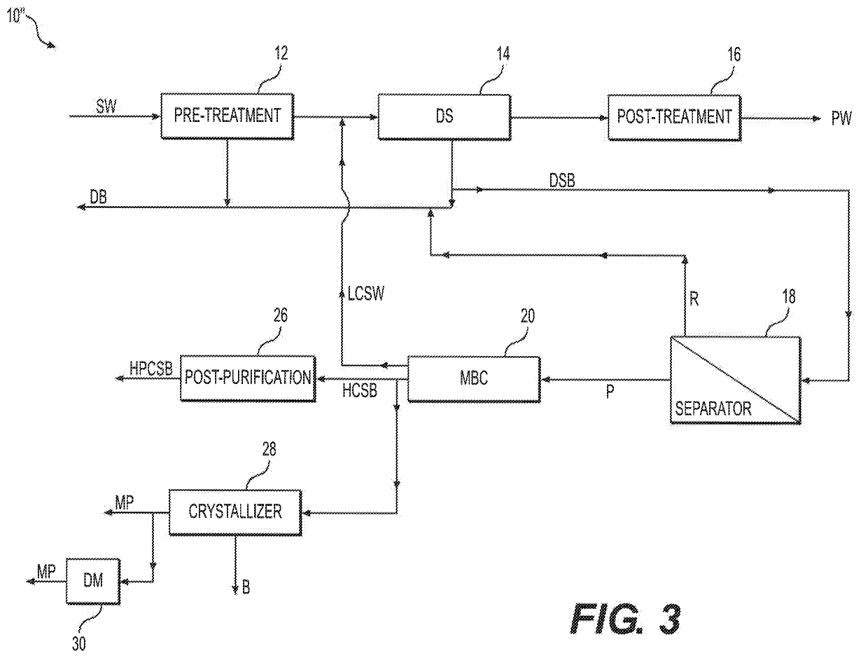

In the alternative embodiment of FIG. 3, the system and method for harvesting minerals from desalination brine 10″ is similar to the system and method for harvesting minerals from desalination brine 10′ of FIG. 2, but an additional crystallizer 28 is also in fluid communication with the membrane brine concentrator 20 for receiving a portion of the stream of higher concentration salt brine (HCSB) and producing a crystallized mineral product (MP) and a stream of bitterns (B). Crystallizer 28 of FIG. 3 is similar to the crystallizer 22 of FIG. 1. It should be understood that any suitable type of crystallizer may be used. As a non-limiting example, the crystallizer 28 may be a thermal crystallizer. As another non-limiting example, the crystallizer 28 may be a solar evaporation pond. Additionally, similar to dissolving mixer 24 of FIG. 1, in the embodiment of FIG. 3, a dissolving mixer (DM) 30 may be used to produce high purity, highly concentrated NaCl brine from at least a portion of the produced crystal salt output from crystallizer 24.

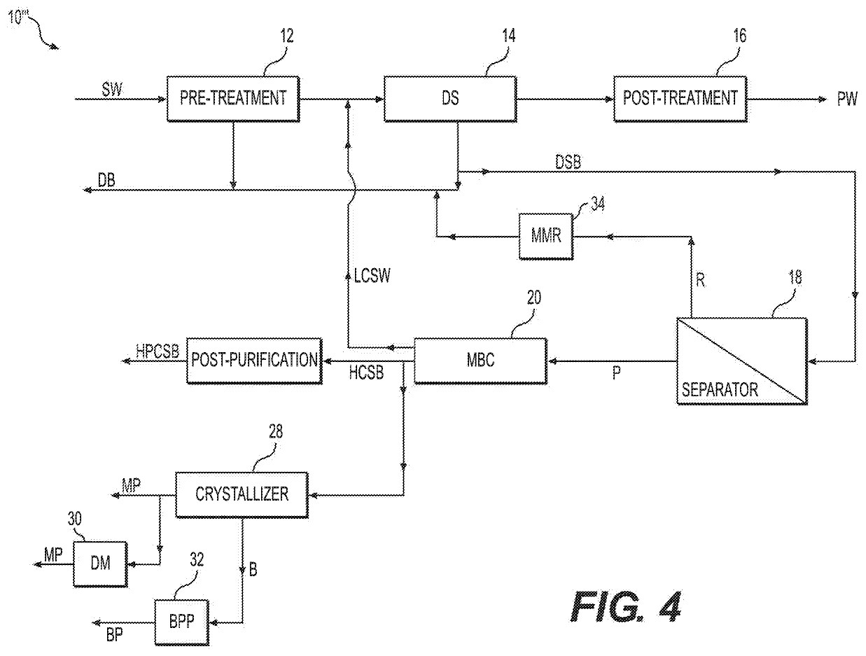

In the alternative embodiment of FIG. 4, the system and method for harvesting minerals from desalination brine 10′″ is similar to the system and method for harvesting minerals from desalination brine 10″ of FIG. 3, but a multivalent mineral recovery (MMR) system 34 is provided for recovering at least a portion of the multivalent ions from the reject (R) stream output from the separator 18. Non-limiting examples of minerals which can be recovered from the reject stream include calcium (Ca⁺⁺) and magnesium (Mg⁺⁺). Additionally, a byproduct production (BPP) module 32 has been added for extracting byproducts (BP) from the bitterns B output by crystallizer 28. In the example of seawater being used as the saltwater feed for system 10′″, desalination brine application, the bitterns may include bromide (Br⁻), potassium (K⁺), calcium (Ca⁺⁺), magnesium (Mg⁺⁺), etc. Extraction of these minerals from bitterns B at this stage is much easier than earlier in the process, since they are in higher concentrations than at any point upstream in the process.

It is to be understood that the system and method for harvesting minerals from desalination brine is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

I claim:

1. A system for harvesting minerals from desalination brine, comprising:
a desalination module for receiving a stream of saltwater and producing a stream of purified water and a stream of desalination brine, the stream of desalination brine including a first portion and a second portion;
a separator in fluid communication with the desalination module for receiving the first portion of the stream of desalination brine and separating monovalent ions from multivalent ions in the first portion of the stream of desalination brine, the separator outputting a reject stream including the multivalent ions and a permeate stream including the monovalent ions, the second portion of the stream of desalination brine being expelled as a stream of discharge brine, the reject stream being mixed with the second portion of the stream of desalination brine;
a membrane brine concentrator in fluid communication with the separator for receiving the permeate stream and producing a stream of lower concentration saltwater and a stream of higher concentration salt brine, the stream of lower concentration saltwater being mixed with the stream of saltwater received by the desalination module; and
a crystallizer in fluid communication with the membrane brine concentrator for receiving the stream of higher concentration salt brine and producing a crystallized mineral product and a stream of bitterns.

2. The system for harvesting minerals from desalination brine as recited in claim 1, wherein said separator comprises a nano-filtration separator.

3. The system for harvesting minerals from desalination brine as recited in claim 1, wherein said separator comprises an electrodialysis separator.

4. The system for harvesting minerals from desalination brine as recited in claim 1, wherein said crystallizer comprises a thermal crystallizer.

5. The system for harvesting minerals from desalination brine as recited in claim 1, wherein said crystallizer comprises a solar evaporation pond.

6. A system for harvesting minerals from desalination brine, comprising:
a desalination module for receiving a stream of saltwater and producing a stream of purified water and a stream of desalination brine, the stream of desalination brine including a first portion and a second portion;
a separator in fluid communication with the desalination module for receiving the first portion of the stream of desalination brine and separating monovalent ions contained therein from multivalent ions, the separator outputting a reject stream containing the multivalent ions and a permeate stream containing the monovalent ions, the second portion of the stream of desalination brine being expelled as a stream of discharge brine, the reject stream being mixed with the second portion of the stream of desalination brine;
a membrane brine concentrator in fluid communication with the separator for receiving the permeate stream and producing a stream of lower concentration saltwater and a stream of higher concentration salt brine, the stream of lower concentration saltwater being mixed with the stream of saltwater received by the desalination module; and
a post-purifier in fluid communication with the membrane brine concentrator for receiving the stream of higher concentration salt brine and producing a purified and concentrated salt brine.

7. The system for harvesting minerals from desalination brine as recited in claim 6, wherein the post-purifier is selected from the group consisting of a clarifier, a bromide removal module and a combination thereof.

8. The system for harvesting minerals from desalination brine as recited in claim 6, wherein said separator comprises a nano-filtration separator.

9. The system for harvesting minerals from desalination brine as recited in claim 6, wherein said separator comprises an electrodialysis separator.

10. The system for harvesting minerals from desalination brine as recited in claim 6, further comprising a crystallizer in fluid communication with the membrane brine concentrator for receiving a portion of the stream of higher concentration salt brine and producing a crystallized mineral product and a stream of bitterns.

11. The system for harvesting minerals from desalination brine as recited in claim 6, further comprising a multivalent mineral recovery system for recovering at least a portion of the multivalent ions from the reject stream output from the separator.

12. A method of harvesting minerals from desalination brine, comprising the steps of:
desalinating a stream of saltwater to produce a stream of purified water and a stream of desalination brine, the stream of desalination brine including a first portion and a second portion;
separating monovalent ions from multivalent ions in the first portion of the stream of desalination brine;
mixing a reject stream including the multivalent ions with the second portion of the stream of desalination brine;
separating a permeate stream including the monovalent ions into a stream of lower concentration saltwater and a stream of higher concentration salt brine;
mixing the stream of lower concentration saltwater with the stream of saltwater; and
producing a crystallized mineral product and a stream of bitterns from the stream of higher concentration salt brine.

13. The method of harvesting minerals from desalination brine as recited in claim 12, wherein said step of separating the monovalent ions from the multivalent ions comprises nano-filtration of the first portion of the stream of desalination brine.

14. The method of harvesting minerals from desalination brine as recited in claim 12, wherein said step of separating the monovalent ions from the multivalent ions comprises electrodialysis of the first portion of the stream of desalination brine.

15. The method of harvesting minerals from desalination brine as recited in claim 12, wherein said step of producing the crystallized mineral product comprises thermal crystallization of the stream of higher concentration salt brine.

16. The method of harvesting minerals from desalination brine as recited in claim 12, wherein said step of producing the crystallized mineral product comprises input of the stream of higher concentration salt brine to a solar evaporation pond.

17. The method of harvesting minerals from desalination brine as recited in claim 12, wherein said step of separating the permeate stream including the monovalent ions into the stream of lower concentration saltwater and the stream of higher concentration salt brine comprises membrane concentration of the permeate stream.

18. The method of harvesting minerals from desalination brine as recited in claim 17, wherein the membrane concentration of the permeate stream comprises osmotically assisted reverse osmosis concentration of the permeate stream.
